(19) United States
(12) Patent Application Publication
(10) Pub. No.: US 2013/0054729 A1
(43) Pub. Date: Feb. 28, 2013

(54) SYSTEM AND METHOD FOR PRE-FETCHING AND CACHING CONTENT

(71) Applicants: Sharad Jaiswal, Bangalore (IN); Naidu K V M, Bangalore (IN); Anirban Majumder, Bangalore (IN); Girija Narlikar, Bangalore (IN); Nisheeth Shrivastava, Karnataka (IN)

(72) Inventors: Sharad Jaiswal, Bangalore (IN); Naidu K V M, Bangalore (IN); Anirban Majumder, Bangalore (IN); Girija Narlikar, Bangalore (IN); Nisheeth Shrivastava, Karnataka (IN)

(21) Appl. No.: 13/508,136

(22) PCT Filed: Nov. 4, 2010
(86) PCT No.: PCT/EP10/66846

§ 371 Date: Nov. 16, 2012

(30) Foreign Application Priority Data
Nov. 6, 2009 (IN) 2714CHE2009

(51) Int. Cl. G06F 15/16; G06F 15/167

(52) U.S. Cl. 709/213; 709/217

(57) ABSTRACT

A system and method for caching and pre-fetching content is disclosed. This invention relates to mobile devices and, more particularly but not exclusively, to delivering content to a mobile device. Existing systems employ different mechanisms for delivering content such as multimedia and the like to users of mobile device. Mechanisms such as broadcast services, delivery from the interne, Wi-Fi hotspots, Bluetooth kiosks etc face problems of offering innovative services to users due to insufficient network capacity, high end costs to consumers. The disclosed system delivers contents such as multimedia, data and the like by pre-fetching and caching techniques. The contents preferred by a user is identified and pre-fetched to access points located in vicinity of the user. The user can access the contents from the access points via a short range communication means such as Bluetooth, Infrared and so on.

### FIELD OF INVENTION

This invention relates to mobile devices and, more particularly but not exclusively, to delivering content to mobile devices.

### BACKGROUND

User interest in exchanging information and entertainment related data over the mobile devices is high in emerging markets. Mobile applications that deliver rich multimedia content over the cellular networks are widely available. However, such mobile applications have not yet taken off in the markets due to several problems. Present mechanisms face insufficient network capacity for delivering rich media content due to lack of pervasive 3G infrastructure. Even in case of 3G systems, there are problems associated with handling large number of users when transmitting rich media content. In addition, operators prefer to add more customers for a particular service rather than adding new and improved innovative services, since addition of innovative services adds to the cost on the operator side (especially if the services have to be priced low to attach large number of users). Cost to end customers for such innovative services is also high and not desirable.

Several mechanisms are employed for real time delivery of data and media content to mobile devices. Some systems deliver internet content such as multimedia and so on over the air. User experience is poor in such systems. Coupled with higher costs, usage of such systems is very low.

Mobile TV services broadcast a few channels to users over the air. Services like Digital Video Broadcasting Handheld (DVB-H) or MediaFlo deliver few channels as chosen by the operator. F-L-O in MediaFlo stands for forward link only. Data transmission in such systems is only one way i.e., downloads only. Personalized content delivery or sharing and uploading content is not possible in broadcast networks.

Content can also be delivered over the internet in uplink and downlink directions. With 2G, 2.5G and even 3G networks, only a small number of users in dense urban areas can be served with such a bandwidth-hungry service. Over-the-air centralized radio access network (single base station serving a large number of users) remains the limiting bottleneck.

Further, users can download and upload content through the internet and share it with other users through a Personal Computer (PC). The link to the PC can be either wireless over Bluetooth or wired over a cable. However, this requires the user to own a PC and an internet connection. PC and broadband penetration remains very low in emerging markets like India.

Users can also upload or download content through a WiFi hotspot. Transferring large amounts of media from a mobile device over WiFi is not battery friendly. With such hotspots, storage conservation and backhaul costs are important problems that need to be addressed. In order to address such problems, appropriate caching strategies need to be developed.

There exist a few ventures based on serving a small quantity of local content from Bluetooth kiosks. The content includes shopping coupons, promotional clips and so on. Such limited content services can rely on a limited backhaul network, or even content being loaded locally at the kiosk from other media like DVDs. In such services, large amount of diverse content personalized to each user is to be downloaded, uploaded and shared among users. Hence, such services require several optimizations in the content delivery infrastructure to make the service scalable and cost effective.

Another point to note is that the design of cellular networks is progressing towards a “small-cell” architecture. Having cells covering a much smaller area than current day macro-cells allows much greater spatial reuse of radio resources, and allows the network to support many more users.

However, one issue with the existing approach is that given the short-range between a mobile and the access point the throughput of the radio interface can be higher or comparable to the backhaul link of the access point. In fact considering that the number of serving-cells anticipated in such an architecture will be much larger that standard cellular networks, and each such cell requires its own backhaul link, keeping the overall costs of network backhaul will be essential. Thus implying that the backhaul capacity of each of these points will be a bottleneck in the design of such networks.

### SUMMARY

These and other aspects of the embodiments herein will be better appreciated and understood when considered in conjunction with the following description and the accompanying drawings.

A content server in a communication network provided with at least one means configured for identifying contents preferred by user of mobile device fetching contents from interne, identifying access points in the vicinity of mobile device and transmitting the contents to the identified access points. The content server identifies user preferred contents based on any one of preferences of user, history of contents sent to the user, contents downloaded by friends of the user and communities of interest to the user. The content refers to one or more of audio, video, movies, data and images. The mobile device is a wireless communication device like a cell phone, Personal Digital Assistant (PDA). The content server identifies an access point based on location of user of mobile device.

An access point in a communication network configured with at least one means for receiving contents transmitted from content server based on user preference patterns through backhaul network link prior to user making any request, storing contents in a memory storage device and transmitting contents to mobile device. The content is sent to an access point by identifying mobility patterns of a user of the mobile device. The content is transmitted from access point to user of mobile device, when user of mobile device is in the vicinity of access point. The content is transmitted from access point to user of the mobile device, when user of mobile device makes a request for content to access point. The access points provide content to the mobile devices using one of Bluetooth, infrared and femtocell.

A method for fetching and delivering content in a communication network comprising steps of a content server identifying content preferred by a user of a mobile device based on user preference details maintained by the content server. The content server fetches user preferred contents from internet, content server identifying an access point closest to the user, content server sending contents to access point prior to the user making any request for the content and the access point delivering content to mobile device of user. The method identifies the content preferred by the user of mobile device from at least one of requests made by user, social networks created by user device, history of downloads of user, contents downloaded by friends of user. The method wherein content is sent to an access point by identifying mobility patterns of a user of mobile device. The content is fetched to an appropriate access point when user of mobile makes a request for content.

A system for fetching and caching content in a communication network comprising a content server configured for identifying contents preferred by user based on user preference details maintained by the content server. Further, the content server fetching user preferred contents from internet, content server identifying appropriate access point in the vicinity of the user. Access point configured for storing contents preferred by user earlier to user making a request for contents and access point transmitting the contents to the user.

### BRIEF DESCRIPTION OF THE FIGURES

Some embodiments of apparatus and/or methods in accordance with embodiments of the present invention are now described, by way of example only, and with reference to the accompanying drawings, in which:

FIG. 1 illustrates a system architecture, according to embodiments as disclosed herein;

FIG. 2 illustrates a content server, according to embodiments as disclosed herein;

FIG. 3 illustrates an access point, according to embodiments as disclosed herein;

FIG. 4 is a system diagram depicting content delivery through access points for a general population, according to embodiments as disclosed herein;

FIG. 5 is a flow chart depicting content delivery through access points for a general population, according to embodiments as disclosed herein;

FIG. 6 is a system diagram for delivering content services along a railway route, according to embodiments as disclosed herein; and

FIG. 7 is a flow chart depicting a method of delivering content along a railway route, according to embodiments as disclosed herein.

### DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

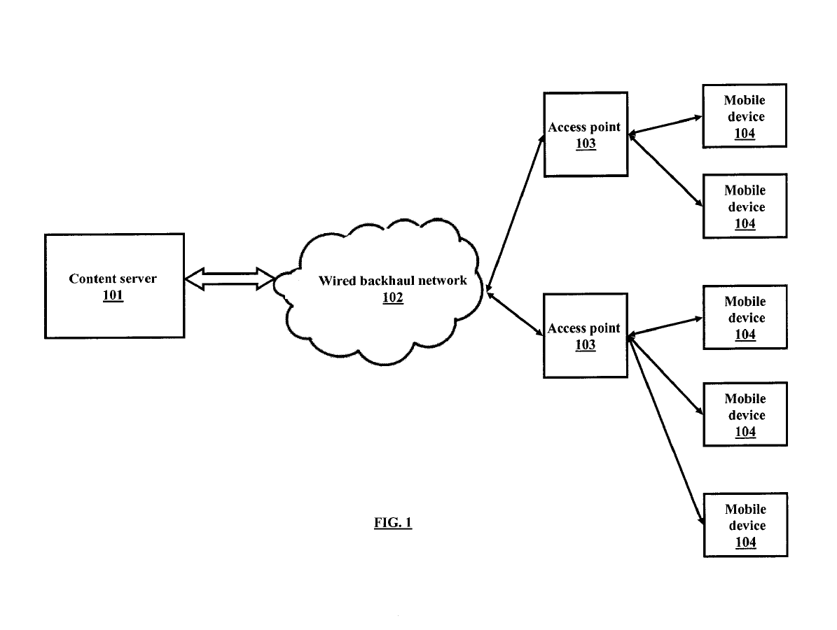

The embodiments herein achieve a method for adaptively pre-fetching and caching content to mobile device by providing a system and method thereof. Referring now to the drawings, and more particularly to FIGS. 1 through 7, where similar reference characters denote corresponding features consistently throughout the figures, there are shown embodiments.

A system and method for pre-fetching and caching content to users of a mobile device is disclosed. Content is delivered to a user via serving cells. To achieve scalability in delivering rich content to mobile devices, the size of the serving cells is reduced. Since the size of serving cells is reduced, it is possible to have a large number of serving cells of small radius spread over a wide area. Each serving cell may have a dedicated network backhaul and may act as an access point. Access point is a device that allows other devices to communicate with it and enables other devices to access contents stored at the access point. Communication can take place either through wired means or wireless means. The access points have a small service area for which the access points can provide their service. The small service area of access points allows users of mobile device to use short range communication means to access the content from the access points. Short range communication means can include Bluetooth, Infrared, femtocells and so on.

Content can be delivered to mobile devices in two steps. At first, predicting where to pre-fetch the content i.e., to determine the access point to which content is to be fetched. An access point that is in close vicinity to the mobile device is chosen to pre-fetch the content. Further, the content to be fetched to the access point is determined. The content to be fetched may be determined based on the user preferences. Content can refer to audio, video, data, text and combination of the same. To pre-fetch the content to appropriate access point, mobility patterns of the users of mobile device may be identified. Mining of mobility points of user may help the network to identify the likeliest access point to be visited by the user, and pre-fetch the content to that particular access point. User preferred contents can be determined by observing sharing patterns of the user, social networks that the user is registered and the like.

Once the preferences of user are determined, the data regarding user preferences is stored on the content server. The content server then sends the contents to appropriate access points through a wired backhaul network. The content is cached at the access point. On occurrence of an event, the content is transferred to the user. Event may be defined as a request from the user to upload or download content or the access point pushing the content preferred by the user. When the user of a mobile device comes in the vicinity of the access point the content is delivered to the user. The content may be delivered to user via a wireless link.

FIG. 1 illustrates system architecture, according to embodiments as disclosed herein. The system comprises a content server 101, a wired backhaul network 102, a plurality of access points 103 and a plurality of mobile devices 104. The content server 101 is responsible for fetching and storing content preferred by a user. The content server 101 fetches the required content from the internet. The content server 101 comprises of a database to maintain the records of user preferences. The content server 101 is also responsible to determine the access point 103, which is closest to the user. The content server 101 transmits the content to the appropriate access point 103. The content server 101 may be provided with logic to identify user preferences. User preferences can be identified depending on the history of contents requested by the user, user indicating his preferences, content uploaded or downloaded by user's friends and so on. In an embodiment, user can also define his network of friends. The content server 101 keeps a track of content uploaded or downloaded by user's friends. The content server 101 may send the contents to access points 103 to deliver the content to user. Also, the content server 101 may obtain new content from the interne which may be preferred by the user. The content server 101 allocates contents from user's content queue to access points 103.

The content fetched from the content server 101 is sent to access point 103 via wired backhaul network 102. Wired backhaul network 102 is a part of the transmission network that acts as a medium for transmission of content. Backhaul network 103 comprises the intermediate links between the core components of the network and small sub components at the edge of the network. The content is sent through the wired backhaul link 102 to the chosen access point 103.

The access points 103 on receiving content from the backhaul link 102 stores or caches the content. The access point 103 is provided with a content delivery system. The content delivery system delivers the content to user's mobile device 104. Access points 103 are equipped with logic to track the user and keep a record of the content the user accesses. Over a period of time, based on content delivered, logic on the access point 103 determines how frequent and for how much period of time the user is available in its vicinity. When the user is near the access point 103, mobile device 104 of the user uploads usage statistics for various contents delivered to the user's mobile device 104. Based on the statistics, the content delivery system learns the content preferred by the user. The content delivery system also learns about the friends of a particular user based on the persons with whom the user shares his content frequently. Further, the access points 103 co-operate with each other i.e., one access point 103 can continue with uploads or downloads where the previous access point 103 left off.

When a user is in the vicinity of a particular access point 103, the access point 103 delivers content to the user's mobile device 104. The content may be delivered via short range wireless means such as Bluetooth, Infrared and the like.

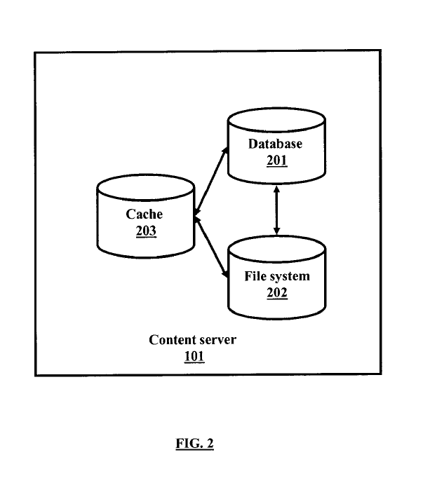

FIG. 2 illustrates a content server, according to embodiments as disclosed herein. The content server 101 comprises a database 201, file system 202 and cache 203. The content server 101 is responsible for fetching and delivering content preferred by the user. The logic on the content server 101 determines type of content preferred by a particular user. In addition, any request from the user to upload or download content is handled by the content server 101. The content required by the user may be fetched from the internet by the content server 101. The fetched content is then transmitted to the appropriate access point 103 via the wired backhaul network 102.

The database 201 on the content server 101 stores the fetched contents. Database 201 is an integration of logically related records or files, which consolidates records previously stored in separate files into a common pool of data records that provides data for many applications. A database 201 is a collection of information that is organized so that it can easily be accessed, managed, and updated. In one view, databases may be classified according to types of content: bibliographic, full-text, numeric, and images. The structure is achieved by organizing the data according to a database model. The contents fetched from the internet may be organized and stored in the database 201. When the content is to be transmitted to the access points 103, content is fetched from the database 201 and delivered to the access point 103.

The file system 202 may be a method for storing and organizing computer files and the data they contain to make it easy to find and access them. File systems 202 may use a data storage device such as a hard disk or CD-ROM and involve maintaining the physical location of the files, they might provide access to data on a file server by acting as clients for a network protocol (e.g., NFS, SMB, or 9P clients), or they may be virtual and exist only as an access method for virtual data distinguished from a directory service and registry. A file system 202 may be a special-purpose database 201 for the storage, organization, manipulation, and retrieval of data. Some of the contents fetched by the content server 101 from the internet are organized as a file system 202 and stored. A file system 202 can be used to organize content and represent access to any content, whether the content be stored or dynamically generated.

The cache 203 may be used for temporary storage of fetched content. A cache 203 may be used for storing content in cases where storage on some other storage means may be expensive due to longer time taken in accessing the stored content. Cache 203 may be defined as a temporary storage area where frequently accessed data can be stored for rapid access. Once the content is stored in the cache 203, the content can be used in the future by accessing the cached copy rather than re-fetching or re-computing the original data. Fetching content form cache 203 is easier then the memory storage devices or components.

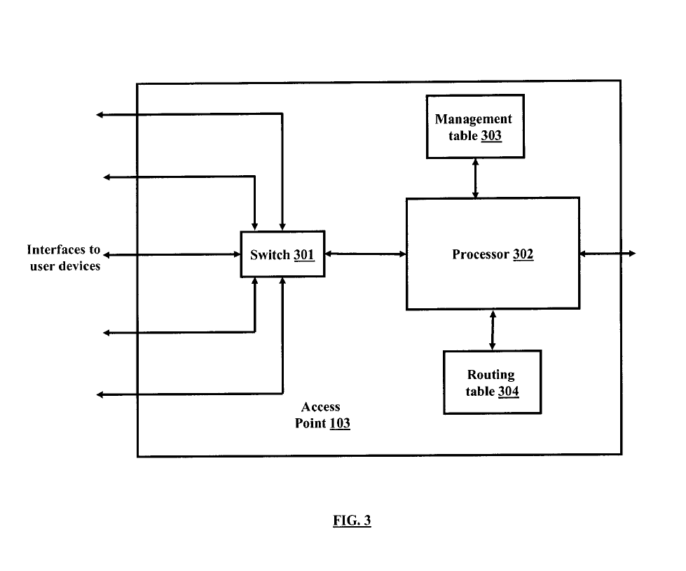

FIG. 3 illustrates an access point, according to embodiments as disclosed herein. An access point 103 comprises of a switch 301, a processor 302, a management table 303, and a routing table 304. The processor 302 performs any necessary checks on the content transmitted. Content may be transmitted in the form of packets. The processor 302 checks the packet header to determine if the packet should be discarded, logged in the router management table 303 or forwarded to the mobile device 104. The processor 302 is also responsible for configuring the forwarding tables used by the switching process. The forwarding tables indicate the mobile device 104 the packet is destined to be sent. The processor 302 computes the forwarding tables by processing the routing table 304.

The routing table 304 comprises lists of details of the location where the mobile device 104 is located. The routing table 304 is constructed by using information supplied when the access point 103 is configured at the time of installation. The processor 302 forwards fetched contents to the switch 301. The switch 301 then forwards the contents to the user device 104 using an air interface. The switch 301 also receives the content sent by the user device 101 and forwards the content to the processor 302 for further processing. The list of authorized access points 103 for a user device 104 is received by the processor 302. The processor 302 determines the address and location of the user device 104, before forwarding the content to the user device 104 using the switch 301. When a user's mobile device 104 is in the vicinity of an access point 103, the processor 302 verifies if the user device 104 is accessible to the access point 103 for transmitting content to the user's mobile device 104. If the user's mobile device 104 is accessible to the access point 103, the access point 103 will send content to the user's mobile device 104.

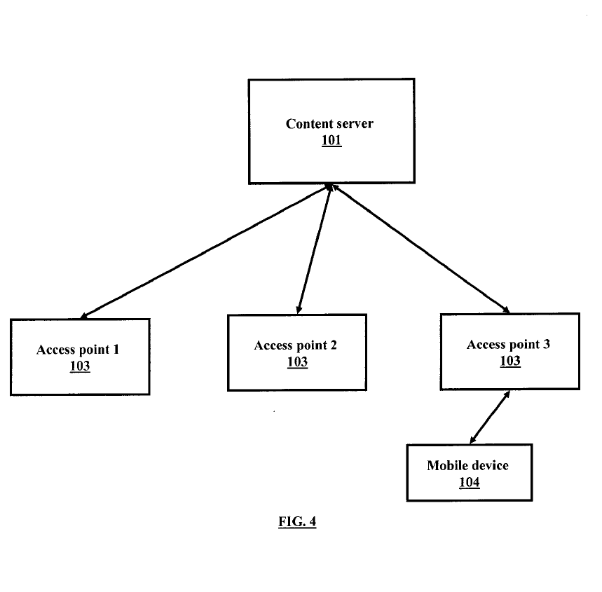

FIG. 4 is a system diagram depicting content delivery through access points for a general population, according to embodiments as disclosed herein. The example discussed in the embodiment below is merely for illustration purpose and does not aim to limit the scope of the method. Consider a case, wherein content is delivered to a college student. The college student commutes everyday from college to home and vice versa. College student also shops frequently in a local store near her home. Mining the details of the college student's commute route, access points 103 can be installed at several locations on the route used by the college student to commute. Access points 103 can be installed in college campus, local shops on the route, bus terminal and the like. The access points 103 may communicate with the mobile device 104 of the college student using any short range communication means like Bluetooth, Infrared and the like. Access points 103 installed at the locations can over time predict how often and for how long a college student will be in its vicinity.

Access points 103 over a period of time may obtain the statistics of content uploaded or downloaded by the college student. The logic on the access point 103 may determine type of content a particular college student may be interested in by examining the statistics on history of content accessed by the college student. In addition, the student can also specify some content of preference such as regional films, movie releases, shopping sales, classical music, news updates and the like. The logic on access points 103 also determines friends of college student, based on whom she shares content with frequently. Based on the student's content preferences and usage, as well as her mobility patterns, the access points 103 frequented by her can pre-fetch and cache content of her liking, or content shared by her friends. All the contents fetched by the content server 101 may be sent to the access point 103. The access point 103 caches the content for delivering the content to the college student.

When the college student is in the vicinity of the access point 103, the mobile device 104 of the student uploads usage statistics of different contents delivered to her mobile device 104. The content is transferred from the access point 103 to the mobile device 104 of the college student. In an embodiment, access points 103 work co-operatively meaning that access points 103 can continue with the uploads or downloads from where the previous access point 103 left off. In an example, if the student is downloading a movie from one access point and moves away from that particular access point 103 when the download is 60% complete. Further, the student can download the remaining 40% of the movie from the next access point 103, when she comes in the vicinity of the access point 103. The student can also link her social networking with the content delivery system. In such a case, when the student creates new content such as photos, video and the like on her social network the same content can preemptively be fetched at the access points 103 frequented by her friends. The fetched content can be shared among her network of friends.

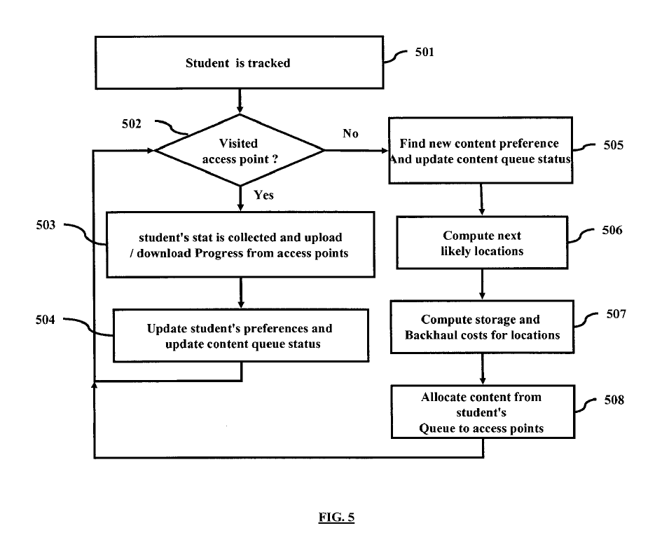

FIG. 5 is a flow chart depicting content delivery through access points for a general population, according to embodiments as disclosed herein. The college student is tracked (501). Tracking here implies that the movement of the student along her route is monitored by the access points 103 in her vicinity. When the student is close to the access point 103, a check (502) is made by the access point to determine if the student is accessible. In case the student is accessible, access points 103 start collecting (503) statistics regarding contents accessed by the student. The contents uploaded or downloaded by the student and the details regarding progress of the upload or download is also recorded by the access points 103. Further, the access point 103 updates (504) student's content preferences and upload or download content's status queue. Once the updating is complete, the sequence of steps 502, 503, 504 is repeated. On the other hand, in case the student is not close to any access point 103 to fetch the content, the access point 103 may find (505) new content from the interne. New content can be obtained by referring to contents shared by student's friends. The student's content queue is then updated by the contents preferred by the student. Further, the content server 101 may determine (506) various locations likely to be visited by the student. The content server 101 may transmit the contents to the identified access points 103 in locations likely to be visited by the student. Storage and backhaul network 102 costs to transmit the content to the access points 103 at desired locations may be determined (507). Further, the stored contents may be transmitted (508) to access points 103 from the access queue. The content is transmitted based on content deadlines, visiting times of the student and location of the student and the like. In an embodiment, the content is stored in the access points for a specified period of time. This period of time may be determined by the configuration of the access point. The access points may be configured to store the data until data is accessed by the user, new content is available and the like. The configuration may be defined by the service. Content sent to the access point may or may not have deadline to be accessed. In case the storage on the access point is running low, then the system can remove some content to make space. This will be done by the system examining usage statistics to determine which contents (already cached in the access point) have a lesser chance of being accessed as compared to new content. So there is no fixed prior deadline for content at an access point. However, content can be removed from time to time to make space. In addition, a user can specifically define a deadline for the content too; i.e. some user may specify that he wants the content within the next 8 hour, hence his requests should be accordingly prioritized and placed on appropriate access points accordingly; i.e. high priority items should definitely be placed at access points where a user spends more time. The sequence of steps 505, 506, 507, 508 is repeated. The various actions in method 500 may be performed in the order presented, in a different order or simultaneously. Further, in some embodiments, some actions listed in FIG. 5 may be omitted.

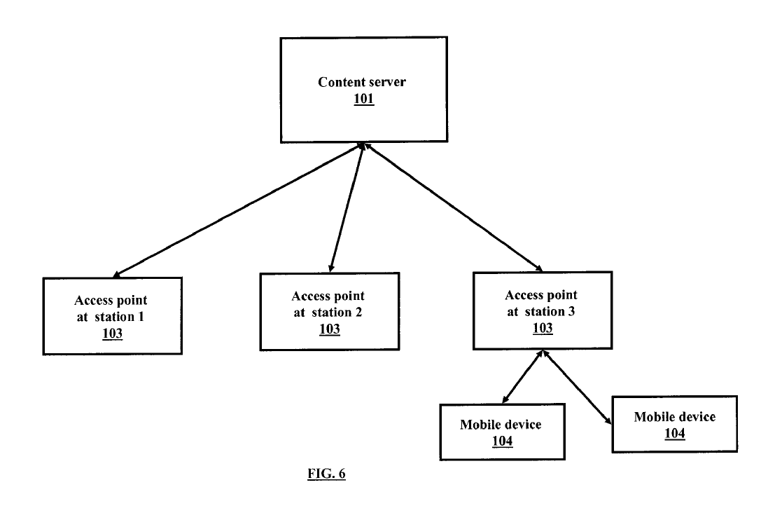

FIG. 6 is a system diagram for delivering content services along a railway route, according to embodiments as disclosed herein. The embodiment herein is only an example for illustrative purposes and does not aim to limit the scope of the application. The content can be delivered to passengers while the passengers are on their journey in a train. In such case, access points 103 may be installed at several intermediate stations on the railway route. Passengers on train can specify their content preferences to be downloaded or uploaded before the journey. Passengers can also make a request to upload their mobile device 104 contents on to the internet. The content may be obtained from a content server 101. The content server 101 may be located away from the railway stations and connected to the internet. The train can also optionally house one or more high-speed content relay points that download or upload content from or to the content access points 103 when the train stops at a railway station. The content preferred by passengers may be fetched by the content server 101 from the internet. The fetched contents may be transmitted to access points 103 located at the stations during the journey. The content server 101 also determines which station (access point 103) to push what content. Content server 101 also determines when to pre-fetch and cache this content. Finally, content server 101 determines at which station the passengers' content is to be uploaded. In an example, if a passenger makes a request for downloading a video clip when he is near station 2. The content server 101 fetches the video clip from the internet and transmits the video clip to the access point 103 located at station 2. The content is transmitted to access point at station 2 since the passenger is near to station 2. The content relay points housed in the train can also help in uploading or downloading contents. When the train arrives at the station, where the access point is located, the content is transmitted from the access point 103 to the mobile device 104 of the user. The content can be pushed or pulled to or from the mobile devices 104 of the user once the train pulls out of the station. Alternately, content can also be transmitted directly from the access points 103 to the passenger's mobile device, without any request for download from the passenger. Since the preferences of the passengers are stored in the access points 103, the content is transmitted to the passenger when the passenger is in the vicinity of the access point 103.

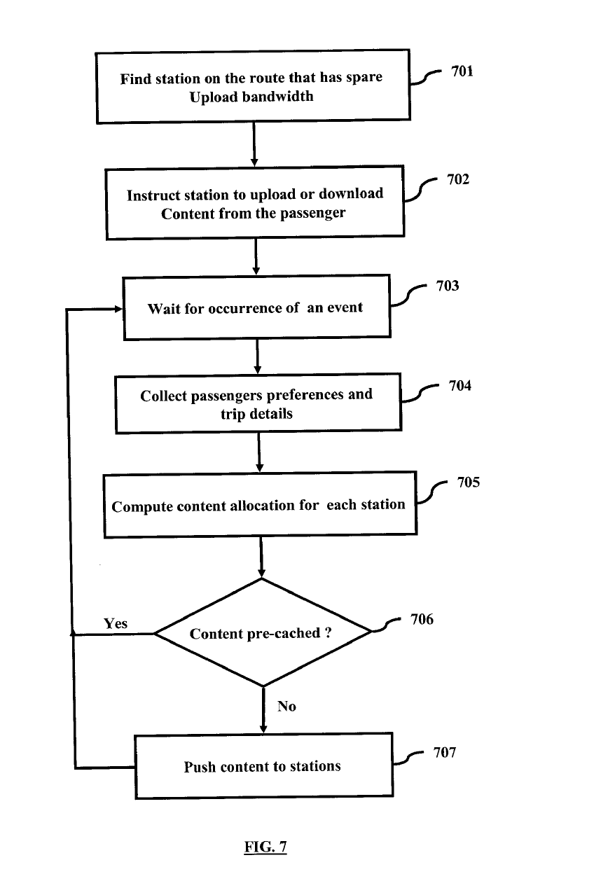

FIG. 7 is a flow chart depicting a method of delivering content along a railway route, according to embodiments as disclosed herein. The content server 101 determines (701) an access point on the route that has a spare upload bandwidth. The access point 103 may be used to upload the content of the passenger from his mobile device 104 to the internet. In case, the access point at the station has a spare bandwidth the content server 101 instructs (702) the access point to upload content from the user's mobile device 104. The content server then waits (703) for occurrence of any event. An event may be a request from the passenger for download, upload or a new passenger making a request and the like. When an event occurs, passenger's content preferences and trip details are collected (704). The trip details can include route of travel, time and so on. Further, the content to be transmitted to each access point 103 may be determined (705). In addition, content popularity, pre-cached content, travel time between stations, stopping time at stations, spare station bandwidth and so on may be considered. A check is made (706) to determine if the content is already pre-cached at the current station's access point 103 or an earlier access point 103. In case the content is already cached, the content server 101 is instructed to wait for the occurrence of an event. The sequence of steps is then repeated. In case the content is not pre-fetched at the access point 103, preferred contents may be pushed to the appropriate access point 103. Also, any content may be uploaded to the access point from the passenger's mobile device 104. The process is repeated until there is no more content to be uploaded or downloaded. The various actions in method 700 may be performed in the order presented, in a different order or simultaneously. Further, in some embodiments, some actions listed in FIG. 7 may be omitted.

The description and drawings merely illustrate the principles of the invention. It will thus be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

The functions of the various elements shown in the FIGS. 1, 2 and 3, including any functional blocks labeled as “processors”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included. Similarly, any switches shown in the FIGS. are conceptual only. Their function may be carried out through the operation of program logic, through dedicated logic, through the interaction of program control and dedicated logic, or even manually, the particular technique being selectable by the implementer as more specifically understood from the context.

What is claimed is:

1. A content server in a communication network, said content server provided with at least one means configured for:
identifying one or more access points used by a user of a mobile device in said communication network by analyzing historical movement pattern of said user;
identifying nature of contents preferred by said user of mobile device at said one or more access points;
pre-fetching contents according to said identified preferences of said user from interne; and
transmitting said contents to identified one or more access points.

2. The content server as in claim 1, wherein said content server identifies user preferred contents based on any one of
preferences of said user;
history of contents sent to said user;
contents downloaded by friends of said user; and
communities of interest to said user.

3. The content server as in claim 1, wherein said content refers to one or more of audio, video, movies, data and images.

4. The content server as in claim 1, wherein said content server identifies an access point based on location of user of mobile device.

5. An access point in a communication network, said access point configured with at least one means for:
receiving contents transmitted from content server, where said contents are chosen based on user preferences;
caching said contents in a memory storage device of said access point; and
transmitting said contents to mobile device.

6. The access point as in claim 5, wherein said access point is further configured to sending said contents to said mobile device by identifying movement patterns of said user of said mobile device.

7. The access point as in claim 5, wherein said access point is further configured to transmitting content to user of mobile device, when said user of said mobile device is in the vicinity of said access point.

8. The access point as in claim 5, wherein said access point is further configured to transmitting content to user of said mobile device, when said user of said mobile device makes a request for said content to said access point.

9. The access points as in claim 5, wherein said access points are further configured to provide content to said mobile devices using one of
Bluetooth;
infrared; and
femtocell.

10. A method for fetching and delivering content in a communication network, said method comprising steps of:
identifying one or more access points used by a user of a mobile device in said communication network by analyzing historical movement pattern of said user;
identifying nature of contents preferred by said user of mobile device at said one or more access points;
pre-fetching contents according to said identified preferences of said user from internet;
transmitting said contents to identified one or more access points;
caching said contents in a memory storage device at said one or more access points; and
transmitting said contents to mobile device when said mobile device is in the vicinity of said one or more access points.

11. The method as in claim 10, wherein said method identifies the content preferred by the user of said mobile device from at least one of:
requests made by user;
social networks created by user device;
history of downloads of user;
contents downloaded by friends of user.

12. The method as in claim 10, wherein said content is sent to an access point by identifying movement patterns of a user of said mobile device.

13. The method as in claim 10, wherein said content is fetched to an appropriate access point when user of mobile makes a request for said content.

14. A system for fetching and caching content in a communication network, said system comprising at least one means configured for:
identifying one or more access points used by a user of a mobile device in said communication network by analyzing historical movement pattern of said user;
identifying nature of contents preferred by said user of mobile device at said one or more access points;
pre-fetching contents according to said identified preferences of said user from internet;
transmitting said contents to identified one or more access points;
caching said contents in a memory storage device at said one or more access points; and
transmitting said contents to mobile device when said mobile device is in the vicinity of said one or more access points.
